(19) United States
(12) Patent Application Publication
(10) Pub. No.: US 2015/0142204 A1
(43) Pub. Date: May 21, 2015

(54) Temperature Control Equipment and Communication Equipment Cabinet

(71) Applicant: Huawei Technologies Co., Ltd., Shenzhen (CN)

(72) Inventors: Dechen Wang, Xi'an (CN); Yanqiong Zeng, Xi'an (CN)

(21) Appl. No.: 14/610,916

(22) Filed: Jan. 30, 2015

Related U.S. Application Data
(63) Continuation of application No. PCT/CN2013/070230, filed on Jan. 8, 2013.

(30) Foreign Application Priority Data
Aug. 1, 2012 (CN) 201210271409.8

(51) Int. Cl. G05D 23/19; G05B 15/02

(52) U.S. Cl. CPC G05D 23/19; G05B 15/02
USPC 700/300

(57) ABSTRACT

The present invention is applicable to the communication equipment field, and in particular, relates to temperature control equipment and a communication equipment cabinet. In the embodiments of the present invention, the temperature control equipment uses an inverter to perform regulated filtering for an alternating current and uses a DC/DC boosting module to boost a direct current, thereby supplying power to the compressor of the temperature control equipment. When the temperature control equipment is powered up by the alternating current power supply and the direct current power supply, the power supply changes from an alternating current to a direct current once the alternating current fails, thereby reducing a fault rate and improving reliability.

This application is a continuation of International Application No. PCT/CN2013/070230, filed on Jan. 8, 2013, which claims priority to Chinese Patent Application No. 201210271409.8, filed on Aug. 1, 2012, both of which are hereby incorporated by reference in their entireties.

### TECHNICAL FIELD

The present invention relates to the communication equipment field, and in particular, to temperature control equipment and a communication equipment cabinet.

### BACKGROUND

A communication equipment cabinet is a cabinet in which communication equipment is installed. A good cabinet can ensure that the communication equipment runs in a favorable environment. The cabinet systematically solves the issues in communication equipment applications, such as high-density heat dissipation, distribution and management of numerous cables, large-capacity power distribution, and all-around compatibility with different vendors' rack-type equipment, thereby ensuring that the communication equipment runs in a highly stable environment.

Currently, temperature control equipment is installed in every communication equipment cabinet. The temperature control equipment can adjust the temperature in the communication equipment cabinet, and ensure that the communication equipment works in a proper temperature. Currently, the temperature control equipment is primarily powered by an alternating current. In some regions with harsh environments, the alternating current alone is not enough for meeting the power supply requirement. When the alternating current power supply fails, the reliability of the communication equipment may decrease for lack of a standby power supply.

### SUMMARY

Embodiments of the present invention provide temperature control equipment where the problem that a conventional temperature control equipment is powered by only an alternating current and is vulnerable to deterioration of working reliability of a communication equipment is solved.

The present invention is implemented in the following way. A temperature control equipment is provided. The temperature control equipment includes a compressor, an inverter, a rectifying module, a power factor correcting module, and an intelligent power module that are connected in sequence. The inverter is connected with an alternating current power supply and the intelligent power module is connected with the compressor. The temperature control equipment further includes a DC/DC boosting module, connected between a direct current power supply and the intelligent power module, and configured to boost a direct current and then supply power to the intelligent power module.

In the above structure, the temperature control equipment further includes an MCU connected with the intelligent power module.

In the above structure, the temperature control equipment further includes a main control circuit connected with the MCU.

In the above structure, the temperature control equipment further includes an auxiliary power supply that is connected with the DC/DC boosting module, the power factor correcting module, the intelligent power module, the MCU, and the main control circuit.

In the above structure, the intelligent power module is an intelligent power chip U1. A first power supply terminal VCC1 of the intelligent power chip U1 is connected with the power factor correcting module, a second power supply terminal VCC2 of the intelligent power chip U1 is connected with the auxiliary power supply, and a control terminal ctrl of the intelligent power chip U1 is connected with the MCU.

Another objective of the present invention is to provide a communication equipment cabinet, where the communication equipment cabinet includes a temperature control equipment installed on a cabinet door. The temperature control equipment includes a compressor and further includes an inverter, a rectifying module, a power factor correcting module, and an intelligent power module that are connected in sequence. The inverter is connected with an alternating current power supply, and the intelligent power module is connected with the compressor.

The temperature control equipment further includes a DC/DC boosting module, connected between a direct current power supply and the intelligent power module, and configured to boost a direct current and then supply power to the intelligent power module.

In the above structure, the temperature control equipment further includes an MCU connected with the intelligent power module.

In the above structure, the temperature control equipment further includes a main control circuit connected with the MCU.

In the above structure, the temperature control equipment further includes an auxiliary power supply that is connected with the DC/DC boosting module, the power factor correcting module, the intelligent power module, the MCU, and the main control circuit.

In the above structure, the intelligent power module is an intelligent power chip U1. A first power supply terminal VCC1 of the intelligent power chip U1 is connected with the power factor correcting module, a second power supply terminal VCC2 of the intelligent power chip U1 is connected with the auxiliary power supply, and a control terminal ctrl of the intelligent power chip U1 is connected with the MCU.

In the present invention, the temperature control equipment uses an inverter to perform regulated filtering for an alternating current and uses a DC/DC boosting module to boost a direct current, thereby supplying power to the compressor of the temperature control equipment. When the temperature control equipment is powered up by the alternating current power supply and the direct current power supply, the power supply changes from an alternating current to a direct current once the alternating current fails, thereby reducing a fault rate and improving reliability. In addition, the equipment is applicable in wider geographic regions. In regions with steady mains supply, the alternating current power supply is applied directly; in regions with unsteady mains supply, a hybrid power supply formed by generators, solar generators, wind turbine generators, and so on, is transformed into a direct current. The complementary use of the alternating current power supply and the direct current power supply improves efficiency, makes the equipment widely applicable, and improves competitiveness greatly.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a circuit module diagram of a temperature control equipment according to an embodiment of the present invention; and

FIG. 2 is a circuit structure diagram of a temperature control equipment according to an embodiment of the present invention.

### DETAILED DESCRIPTION OF ILLUSTRATIVE EMBODIMENTS

To make the objectives, technical solutions, and advantages of the present invention more comprehensible, the following further describes the present invention in detail with reference to the accompanying drawings and embodiments. It is understandable that the specific embodiments are only used to explain the present invention and are not intended to limit the present invention.

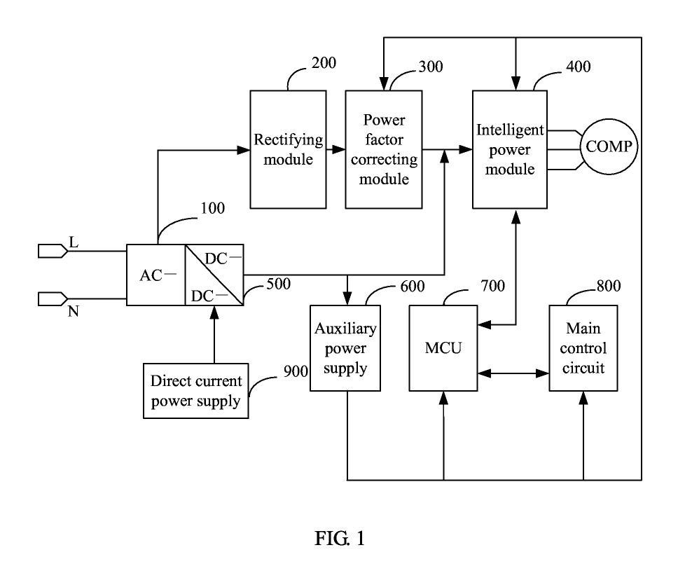

FIG. 1 shows a circuit module structure of a temperature control equipment according to an embodiment of the present invention. For ease of description, only a part related to the embodiment of the present invention is illustrated, and details are given below.

A temperature control equipment includes a compressor COMP. The temperature control equipment further includes an inverter 100, a rectifying module 200, a power factor correcting module 300, and an intelligent power module 400 that are connected in sequence. The inverter 100 is connected with an alternating current power supply, and the intelligent power module 400 is connected with the compressor COMP.

The inverter 100 includes an inverter bridge, a control logic, and a filter circuit. The inverter is configured to convert direct current energy (including but not limited to a battery and a storage battery) into an alternating current (generally 220V/50 HZ).

The rectifying module 200 is configured to convert an alternating current into a direct current. In this embodiment, the rectifying module may be formed by diodes, but without being limited to this implementation.

The power factor correcting module 300 is configured to adjust a waveform of a current and compensate for a phase difference between a current and a voltage. A proactive power factor correcting module can achieve a high power factor—generally over 98%. The power factor correcting module is connected with the rectifying module through a smoothing module (optional), and the rectifying module is connected with the inverter.

The main control circuit collaborates with an MCU (Micro Control Unit, also known as single chip microcomputer Single Chip Microcomputer or single-chip microcomputer), and is configured to collect working data information of the compressor, perform analysis and computing according to the collected information, and provide a control signal for the inverter according to a result of the analysis and computing, to control the working voltage and efficiency of the compressor.

The intelligent power module 400 (IPM, Intelligent Power Module) is an advanced power switching device. It has the advantages of a GTR (giant transistor) such as high current density, a low saturated voltage, and high voltage tolerance, and the advantages of a MOSFET (MOS field effect transistor) such as high input impedance, a high switching frequency, and low drive power. Moreover, a logic circuit, a control circuit, a detection circuit, and a protection circuit are integrated inside the intelligent power module 400, and the module can send a detection signal to a CPU. The module is formed by a high-speed low-power-consumption die, an optimized gate drive circuit, and a quick protection circuit, and is easy to use. The module reduces the size of a system, shortens development time, greatly enhances reliability of the system, and caters for the trend of a power device—being modularized, composite, and power integrated circuit (PIC). The module is more and more widespread in a power electronic field.

The temperature control equipment further includes a DC/DC boosting module 500 connected between the direct current power supply 900 and the intelligent power module 400 to boost a direct current and then supply power to the intelligent power module 400.

In an embodiment of the present invention, the temperature control equipment further includes an MCU 700 connected with the intelligent power module 400.

In an embodiment of the present invention, the temperature control equipment further includes a main control circuit 800 connected with the MCU 700.

In an embodiment of the present invention, the temperature control equipment further includes an auxiliary power supply 600 that is connected with the DC/DC boosting module 500, the power factor correcting module 300, the intelligent power module 400, the MCU 700, and the main control circuit 800.

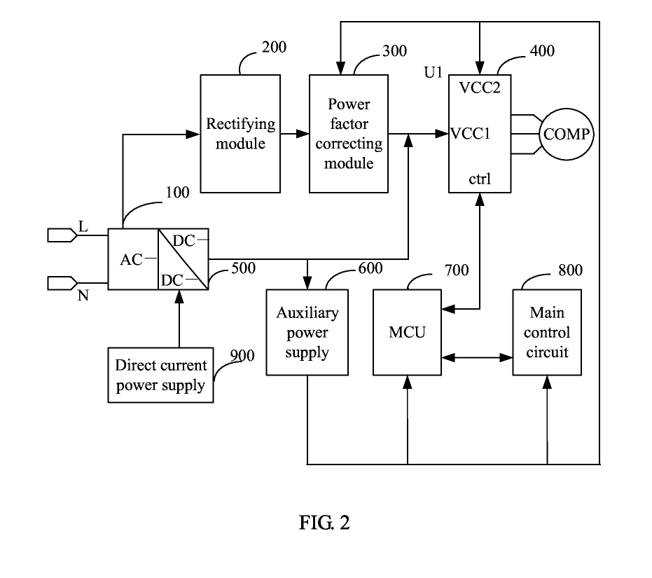

FIG. 2 shows a circuit structure of a temperature control equipment according to an embodiment of the present invention. For ease of description, only a part related to the embodiment of the present invention is illustrated, and details are given below.

In an embodiment of the present invention, the intelligent power module 400 is an intelligent power chip U1. A first power supply terminal VCC1 of the intelligent power chip U1 is connected with the power factor correcting module 300, a second power supply terminal VCC2 of the intelligent power chip U1 is connected with the auxiliary power supply 600, and a control terminal ctrl of the intelligent power chip U1 is connected with the MCU 700.

Further, an embodiment of the present invention provides a communication equipment cabinet, where the communication equipment cabinet includes a temperature control equipment installed on a cabinet door, where the temperature control equipment includes a compressor COMP and further includes an inverter 100, a rectifying module 200, a power factor correcting module 300, and an intelligent power module 400 that are connected in sequence, where the inverter 100 is connected with an alternating current power supply, and the intelligent power module 400 is connected with the compressor COMP.

The temperature control equipment further includes a DC/DC boosting module 500 connected between a direct current power supply 900 and the intelligent power module 400 to boost a direct current and then supply power to the intelligent power module 400.

In an embodiment of the present invention, the temperature control equipment further includes an MCU 700 connected with the intelligent power module 400.

In an embodiment of the present invention, the temperature control equipment further includes a main control circuit 800 connected with the MCU 700.

In an embodiment of the present invention, the temperature control equipment further includes an auxiliary power supply 600 that is connected with the DC/DC boosting module 500, the power factor correcting module 300, the intelligent power module 400, the MCU 700, and the main control circuit 800.

In an embodiment of the present invention, the intelligent power module 400 is an intelligent power chip U1. A first power supply terminal VCC1 of the intelligent power chip U1 is connected with the power factor correcting module 300, a second power supply terminal VCC2 of the intelligent power chip U1 is connected with the auxiliary power supply 600, and a control terminal ctrl of the intelligent power chip U1 is connected with the MCU 700.

In the embodiment of the present invention, the temperature control equipment uses an inverter to perform regulated filtering for an alternating current and uses a DC/DC boosting module to boost a direct current, thereby supplying power to the compressor of the temperature control equipment. When the temperature control equipment is powered up by the alternating current power supply and the direct current power supply, the power supply changes from an alternating current to a direct current once the alternating current fails, thereby reducing a fault rate and improving reliability. Besides, the equipment is applicable in wider geographic regions. In regions with steady mains supply, the alternating current power supply is applied directly; in regions with unsteady mains supply, a hybrid power supply formed by generators, solar generators, wind turbine generators, and so on, is transformed into a direct current. The complementary use of the alternating current power supply and the direct current power supply improves efficiency, makes the equipment widely applicable, and improves competitiveness greatly.

The foregoing description is merely exemplary embodiments of the present invention, but is not intended to limit the present invention. Any modifications, equivalent substitutions, and improvements made within the idea and principle of the present invention shall fall within the protection scope of the present invention.

What is claimed is:

1. A temperature control equipment, comprising:
a compressor;
an inverter with an alternating current input;
a rectifier coupled to an output of the inverter;
a power factor correcting circuit coupled to an output of the rectifier;
an intelligent power module coupled to an output of the power factor correcting circuit; and
a DC/DC boosting circuit, connected between a direct current power supply and the intelligent power module, and configured to boost a direct current and supply power to the intelligent power module.

2. The temperature control equipment according to claim 1, wherein the temperature control equipment further comprises an MCU connected to the intelligent power module.

3. The temperature control equipment according to claim 2, wherein the temperature control equipment further comprises a main control circuit connected to the MCU.

4. The temperature control equipment according to claim 3, wherein the temperature control equipment further comprises an auxiliary power supply respectively connected with the DC/DC boosting circuit, the power factor correcting module, the intelligent power module, the MCU, and the main control circuit.

5. The temperature control equipment according to claim 4, wherein:
the intelligent power module comprises an intelligent power chip;
a first power supply terminal of the intelligent power chip is connected with the power factor correcting module;
a second power supply terminal of the intelligent power chip is connected with the auxiliary power supply; and
a control terminal of the intelligent power chip is connected with the MCU.

6. A communication equipment cabinet, comprising:
a housing including a cabinet door; and
temperature control equipment installed on the cabinet door, the temperature control equipment comprising a compressor, an inverter, a rectifying module, a power factor correcting module, an intelligent power module that are connected in sequence, and a DC/DC boosting module, connected between a direct current power supply and the intelligent power module, the DC/DC boosting module configured to boost a direct current and then supply power to the intelligent power module, wherein the inverter is connected with an alternating current power supply, and the intelligent power module is connected with the compressor.

7. The communication equipment cabinet according to claim 6, wherein the temperature control equipment further comprises an MCU connected with the intelligent power module.

8. The communication equipment cabinet according to claim 7, wherein the temperature control equipment further comprises a main control circuit connected with the MCU.

9. The communication equipment cabinet according to claim 8, wherein the temperature control equipment further comprises an auxiliary power supply respectively connected with the DC/DC boosting module, the power factor correcting module, the intelligent power module, the MCU, and the main control circuit.

10. The communication equipment cabinet according to claim 9, wherein the intelligent power module is an intelligent power chip, a first power supply terminal of the intelligent power chip is connected with the power factor correcting module, a second power supply terminal of the intelligent power chip is connected with the auxiliary power supply, and a control terminal ctrl of the intelligent power chip is connected with the MCU.

11. A temperature control equipment, the temperature control equipment comprising:
a compressor;
an inverter, a rectifying module, a power factor correcting module, and an intelligent power module that are connected in sequence, wherein the inverter is connected with an alternating current power supply, and the intelligent power module is connected with the compressor; and
a DC/DC boosting module, connected between a direct current power supply and the intelligent power module, and configured to boost a direct current and then supply power to the intelligent power module.

12. The temperature control equipment according to claim 11, wherein the temperature control equipment further comprises an MCU connected with the intelligent power module.

13. The temperature control equipment according to claim 12, wherein the temperature control equipment further comprises a main control circuit connected with the MCU.

14. The temperature control equipment according to claim 13, wherein the temperature control equipment further comprises an auxiliary power supply respectively connected with the DC/DC boosting module, the power factor correcting module, the intelligent power module, the MCU, and the main control circuit.

15. The temperature control equipment according to claim 14, wherein the intelligent power module is an intelligent power chip, a first power supply terminal of the intelligent power chip is connected with the power factor correcting module, a second power supply terminal of the intelligent power chip is connected with the auxiliary power supply, and a control terminal ctrl of the intelligent power chip is connected with the MCU.
